(19) United States
(12) Patent Application Publication
(10) Pub. No.: US 2006/0170276 A1
(43) Pub. Date: Aug. 3, 2006

(54) Tire cover

(76) Inventors: Frank J. Szeg III, Perth Amboy, NJ (US); Stephen F. Sisko JR., Iselin, NJ (US)

Correspondence Address: EZRA SUTTON;Plaza 9, Suite 201, 900 Route 9 North, Woodbridge, NJ, 07095, US

(21) Appl. No.: 11/047,086

(22) Filed: Jan. 31, 2005

(51) Int. Cl. B60B 7/00

(52) U.S. Cl. 301/37.42

(57) ABSTRACT

A detachable tire cover assembly for a vehicle that raises the riding height of the vehicle such that the vehicle may be rolled onto a ramp of a transport vehicle without damage. The detachable tire cover assembly includes a first circular shaped section, and a second circular shaped section; the first and second circular shaped sections each include an exterior wall and side walls thereon for forming first and second tire receiving compartments therein; and each of the first and second tire receiving compartments are for receiving a portion of a tire therein. The first circular shaped section has a first end and a second end; and the second circular shaped section has a third end and a fourth end. The first and third ends include buckle snaps thereon for connecting the first and second circular shaped sections of the tire cover assembly to enclose a portion of a tire therein; and the second and fourth ends include tab connectors thereon for connecting the first and second circular shaped sections of the tire cover assembly to enclose a portion of a tire therein.

### FIELD OF THE INVENTION

The present invention is for a tire cover assembly that raises the riding height of a vehicle in order for the vehicle to be rolled onto a ramp for transport without any damage to the lower front end or back end of the vehicle. More particularly, the tire cover assembly includes two semi-circular rigid, molded halves that are connected together to form a complete circular tire cover.

### BACKGROUND OF THE INVENTION

Transportation of drag racing vehicles, racing cars and dragsters on transport vehicles are well known in the art. Such racing vehicles have a problem of gaining access onto the ramp devices of the transport vehicles as the front lower end or the rear lower end of these racing-type vehicles bottom-out and get dented as they gain access to the ramp devices. In turn, the front lower end or the rear lower end of these racing-type vehicles are damaged as they are brought onto the ramp device of the transport vehicle.

There remains a need for a detachable tire cover for a racing-type vehicle that raises the riding height of the racing-type vehicle such that it is easily rolled onto an access ramp of a transport vehicle without causing any damage to a lower front end or a lower back end of the racing-type vehicle being transported on a transport vehicle. Additionally, the detachable tire cover should include two semi-circular rigid or molded half sections that are connected together to form a complete circular tire cover.

### DESCRIPTION OF THE PRIOR ART

Tire and wheel covers, protective tire covers and the like having various designs, structures, configurations and materials of construction have been disclosed in the prior art. For example, U.S. Pat. No. 6,116,415 to RASTELLI discloses a tire and wheel cover with one size to expand over many size tires and wheels. Two sections of covering material are used, a detachable center section for viewing the wheel and a wide circumferential section of material for covering the tire. The two sections are removably attached to each other in order to allow for viewing of the wheel. The circumferential section of material on the rear side has a hollow unfold with an elastic cord inside. This prior art patent does not disclose or teach the structure of the tire cover assembly of the present invention.

U.S. Pat. No. 6,044,968 to IAMPEN discloses a tire protective cover for covering and protecting a static mounted tire from environmental hazards, wherein the environmental hazards include ultra-violet radiation and air-borne contaminants, such as corrosive fluids or paint protection from dogs urinating on rims and tires. The tire cover includes a resilient casing for covering both sides of a tire, wherein the resilient casing covering the one side of the tire has a generally circular member having a radially adjacent series of sequentially raised concentric annular surfaces. Lugs are provided for gripping, and structurally reinforcing, the concentrically inner, center portion of the cover. This prior art patent does not disclose or teach the structure of the tire cover assembly of the present invention.

U.S. Pat. No. 5,248,235 discloses a dolly or roll carriage serving as a traveling aid for a defective wheel on a motor vehicle. The dolly includes an undercarriage equipped with rollers, a ramp plate for the driving ascent thereon of the defective wheel. Also a well is provided for the receipt of the wheel and for the lateral or sideways fixing of the wheel. In addition, a front stop member is provided for the wheel whereby the stop member is generally configured in the shape of a wheel rim. This prior art patent does not disclose or teach the structure of the tire cover assembly of the present invention.

None of the aforementioned prior art references disclose or teach the specific structure of the tire cover of the present invention having two semi-circular rigid and molded halves that are connected together by buckle and tab connectors to form a complete circular tire cover.

Accordingly, it is an object of the present invention to provide a tire cover assembly having a pair or rigid, molded semi-circular halves that are connected together by connectors to form a complete circular tire cover.

Another object of the present invention is to provide a tire cover assembly that raises the riding height of a vehicle in order for the vehicle to be rolled onto a ramp of a transport vehicle without any denting or damage to the lower front end or back end of vehicle.

Another object of the present invention is to provide a tire cover assembly that is easy to assemble, install and remove, and is made from durable materials such as plastic or rubber, and is easy to clean.

Another object of the present invention is to provide a tire cover assembly that can be mass produced in an automated and economical manner and is readily affordable by the user.

### SUMMARY OF THE INVENTION

In accordance with the preferred embodiment of the present invention, there is provided a detachable tire cover assembly for a vehicle that raises the riding height of the vehicle such that the vehicle may be rolled onto a ramp of a transport vehicle without damage. The detachable tire cover assembly includes a first circular shaped section, and a second circular shaped section; the first and second circular shaped sections each include an exterior wall and side walls thereon for forming first and second tire receiving compartments therein; and each of the said first and second tire receiving compartments are for receiving a portion of a tire therein. The first circular shaped section has a first end and a second end; and said second circular shaped section has a third end and a fourth end. The first and third ends include connectors thereon for connecting the first and second circular shaped sections of the tire cover to enclose a portion of a tire therein; and the second and fourth ends include connectors thereon for connecting the first and second circular shaped sections of the tire cover assembly to enclose the tire therein.

In an alternate embodiment of the present invention, there is provided a detachable tire cover assembly for a vehicle that raises the riding height of the vehicle such that the vehicle may be rolled onto a ramp of a transport vehicle. The detachable tire cover assembly includes an elongated tire base member having a first end and a second end. The elongated tire base member includes an exterior wall and side walls thereon for forming a tire receiving compartment for receiving a tire therein; and the first and second ends have buckle and tab connectors, respectively, thereon for connecting the first and seconds ends to form a complete circular tire cover assembly for enclosing the tire within the tire receiving compartment.

### BRIEF DESCRIPTION OF DRAWINGS

Further objects, features and advantages of the present invention will become apparent upon the consideration of the following detailed description of the presently preferred embodiment when taken in conjunction with the accompanying drawings, wherein;

FIG. 1 is an exploded perspective view of the tire cover assembly of the preferred embodiment of the present invention showing a pair of semi-circular shaped half sections having connectors thereon;

FIG. 2 is a perspective view of the tire cover assembly of the present invention showing the semi-circular shaped half sections in a closed configuration and in an assembled state without a tire therein;

FIG. 3 is an exploded perspective view of the tire cover assembly of the present invention showing each of the semi-circular shaped half sections being mounted to a tire;

FIG. 4 is a perspective view of the tire cover assembly of the present invention showing the semi-circular shaped half sections in a closed configuration and in an assembled state having a tire therein, and in operational use;

FIG. 5 is a perspective view of the tire cover assembly of an alternate embodiment of the present invention showing an elongated tire base member having a tire receiving compartment for mounting a tire therein;

FIG. 5A is a perspective view of the tire cover assembly of the present invention showing first and second ends of the tire base member having connectors thereon, respectively, in the form of hook and loop fasteners;

FIG. 6 is a perspective view of the tire cover assembly of the present invention showing the tire being mounted within the tire receiving compartment in an open configuration;

FIG. 6A is a perspective view of the tire cover assembly of the present invention showing first and second ends of the tire base member having connectors thereon, respectively, in the form of snap connecting members;

FIG. 7 is a perspective view of the tire cover assembly of the present invention showing buckle and tab connectors on each end of the tire base member being together to form a complete circular tire cover assembly in its closed configuration; and

FIG. 7A is a perspective view of the tire cover assembly of the present invention showing first and second ends of the tire base member having-connectors thereon, respectively, in the form of buckle and tab connectors;

FIG. 8 is a perspective view of the tire cover assembly of the present invention showing the tire cover mounted to the tire in its closed configuration and in an assembled state having the tire therein, and in operational use.

### DETAILED DESCRIPTION OF THE EMBODIMENTS

### Preferred Embodiment 10

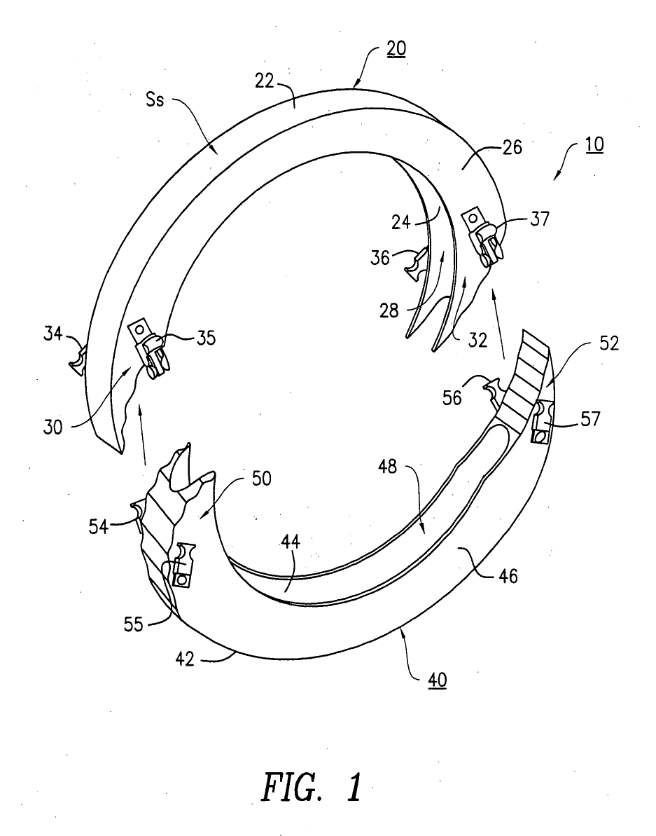

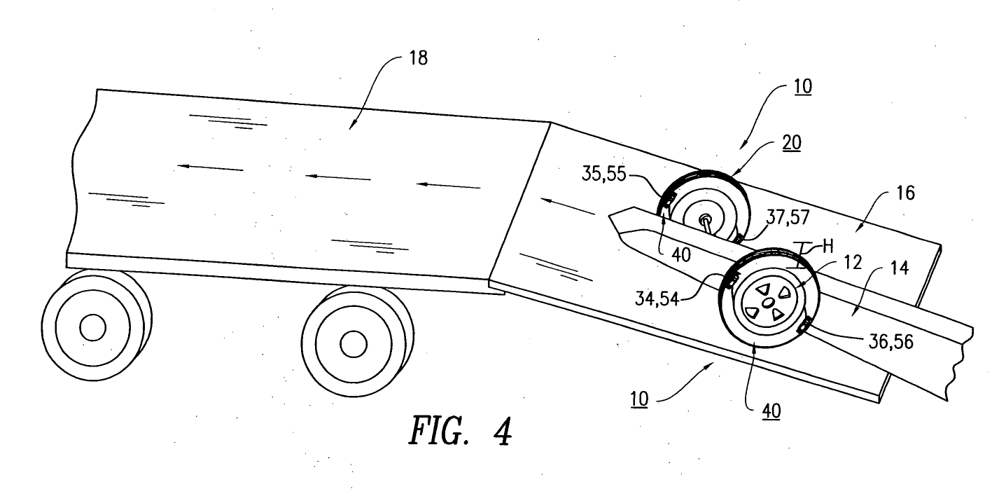

The detachable tire cover assembly 10 and its component parts of the preferred embodiment of the present invention is represented in detail by FIGS. 1 through 4 of the patent drawings. The detachable tire cover assembly 10 is used for enclosing tires 12 on a rim 13 of a vehicle 14 in order for the riding height H to be raised such that the vehicle 14 may be rolled onto a ramp 16 of a transport vehicle 18, as shown in FIG. 4 of the drawings, which will eliminate or minimize any damage to the lower front end or lower rear end of the vehicle 14 being transported.

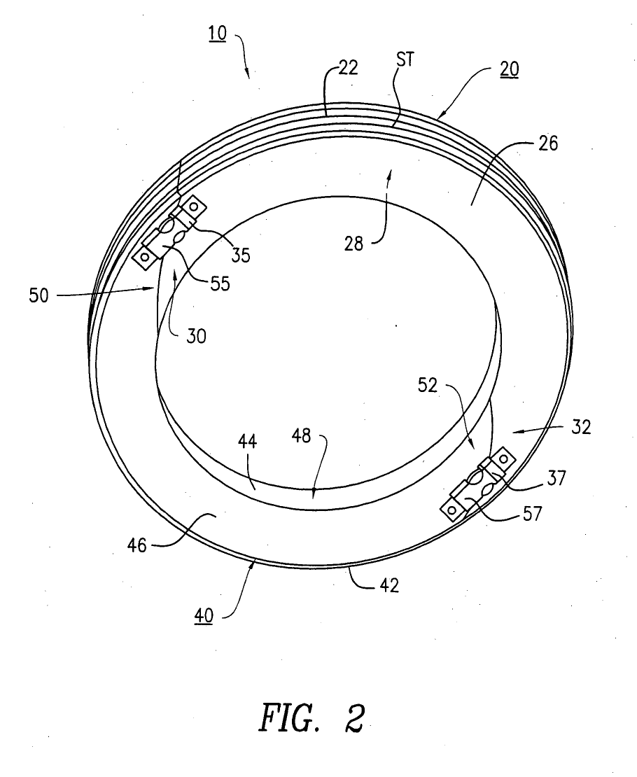

As shown in FIGS. 1 through 3 of the drawings, the detachable tire cover assembly 10 includes a first semi-circular shaped half section 20 and a second semi-circular shaped half section 40. In alternate design configurations, the detachable tire cover assembly 10 may have other circular shaped sections that are not matching or half shapes. The first circular shaped half section 20 includes an exterior wall 22, a first side wall 24, a second side wall 26 thereon for forming a first tire receiving recess or compartment 28 for receiving a portion of tire 12 therein. The first circular shaped half section 20 also includes a first end 30 and a second end 32 each having a pair of buckle connectors 34, 35 and 36, 37 being positioned on each of the side walls 24 and 26 of each end 30 and 32, respectively, of the first circular shaped half section 20, as depicted in FIG. 1 of the drawings, for connecting the first and second circular shaped half sections 20 and 40 together. The exterior wall 22 may be made with a smooth surface S_{S} or made with a tread-like surface or ridged surface S_{T}, as shown in FIGS. 1 and 2 of the drawings. The exterior wall 22 has a depth in the range of three (3) to five (5) inches for increasing the radius R of the original tire 12. The first tire receiving compartment (recess) 28 has an interior depth of at least three (3) inches for receiving a portion of the original tire 12 therein.

The second circular shaped half section 40 includes an exterior wall 42, a first side wall 44, a second side wall 46 thereon for forming a second tire receiving recess or compartment 48 for receiving a portion of tire 12 therein. The second circular shaped half section 40 also includes a third end 50 and a fourth end 52 each having a pair of tab connectors 54, 55 and 56, 57 being positioned on each of the side walls 44 and 46 of each end 50 and 52, respectively, of the second circular shaped half section 40, as depicted in FIG. 1 of the drawings, for connecting the first and second circular shaped half sections 20 and 40 together. The exterior wall 42 may be made with a smooth surface Sₛ or made with a tread-like surface or ridged surface S_{T}, as shown in FIGS. 1 and 2 of the drawings. The exterior wall 22 has a depth in the range of three (3) to five (5) inches for increasing the radius R of the original tire 12. The second tire receiving compartment (recess) 48 has an interior depth of at least three (3) inches for receiving a portion of the original tire 12 therein.

The first and seconds ends 30 and 32 of the first circular shaped-half section 20 are mated and matched with the third and fourth ends 50 and 52 of the second circular shaped half section 40, respectively, such that the buckle connectors 34 and 35 are connected with the tab connectors 54 and 55 at the first and third ends 30 and 50 of half sections 20 and 40, respectively, as well as the buckle connectors 36 and 37 are connected with the tab connectors 56 and 57 at the second and fourth ends 32 and 52 of half sections 20 and 40, respectively, in order to form a complete circular tire cover assembly 10 in which to transport vehicle 14 onto ramp 16 of the transport vehicle 18, as shown in FIG. 4 of the drawings. The tire cover 10 can be made from moldable and rigid plastic materials or rubber materials.

### Alternate Embodiment 100

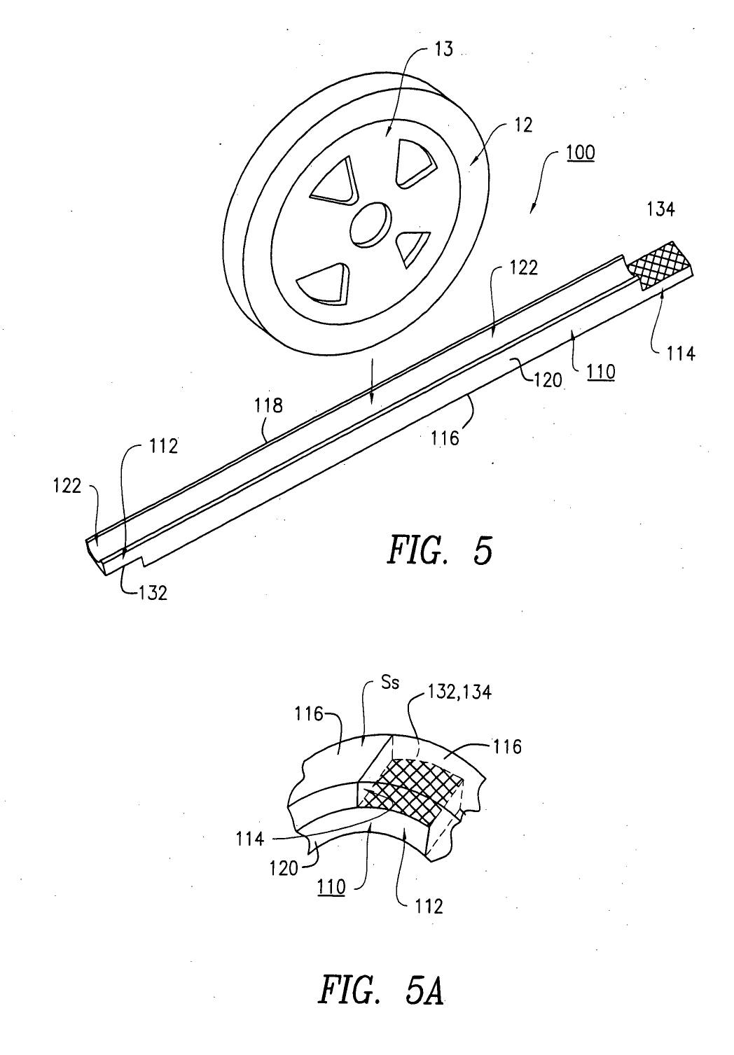

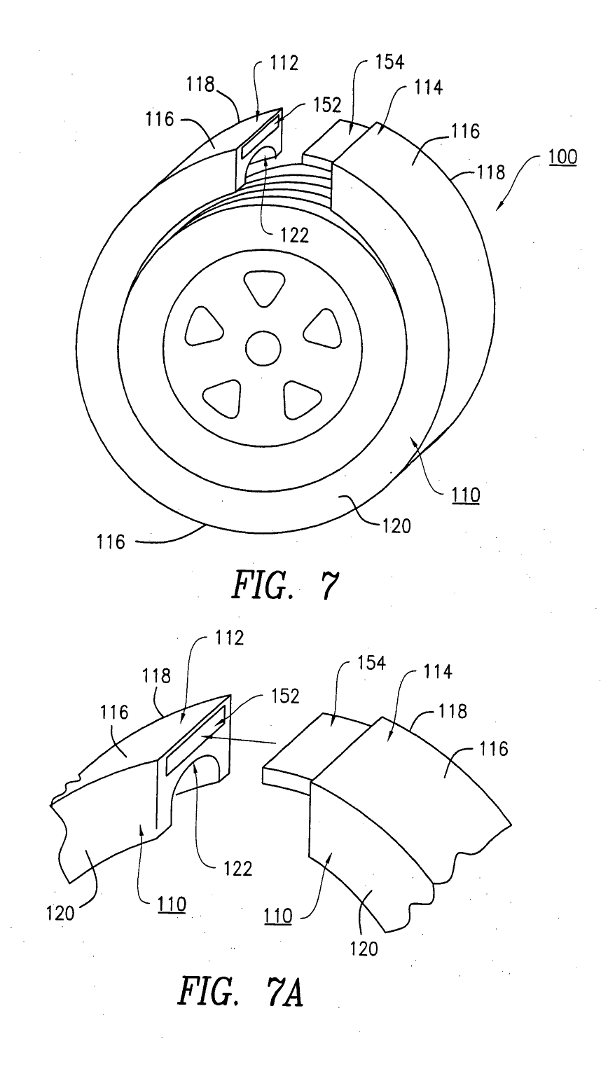

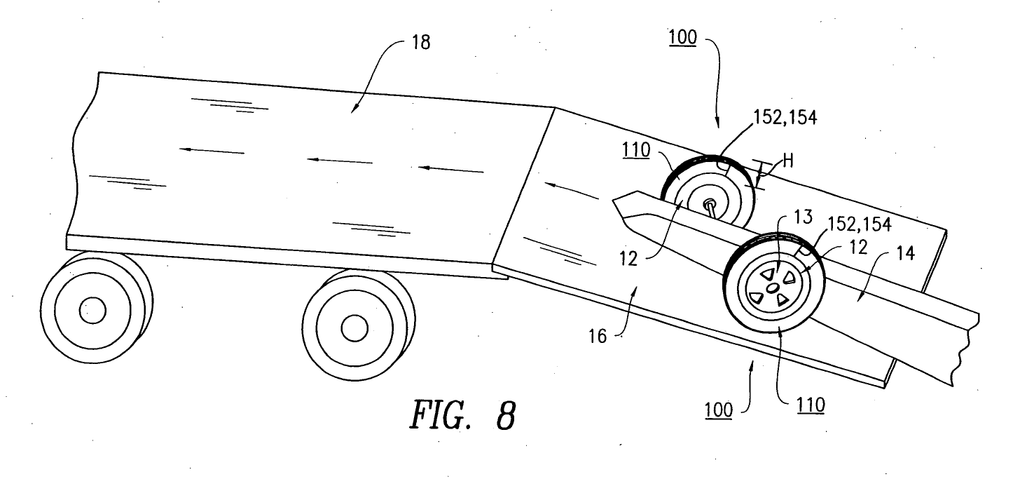

The detachable tire cover assembly 100 and its component parts of the alternate embodiment of the present invention is represented in detail by FIGS. 5 through 8 of the patent drawings. The detachable tire cover assembly 100 is used for enclosing tire 12 on a rim 13 of a vehicle 14 in order for the riding height H to be raised such that the vehicle 14 may be rolled onto a ramp 16 of a transport vehicle 18, as shown in FIG. 8 of the drawings, which will eliminate or minimize any damage to the lower front end or lower rear end of the transported vehicle 14.

As shown in FIGS. 5 through 8 of the drawings, the detachable tire cover assembly 100 includes an elongated tire base member 110 having a first end 112 and a second end 114. The elongated tire base member 110 further includes an exterior wall 116, a first side wall 118, a second side wall 120 thereon for forming a tire receiving compartment or-recess 122 for receiving a tire 12 therein. The first end 112 of tire base member 110 includes a hook fastener 132 and second end 114 of tire base member 110 includes a loop fastener 134 for connecting the first and second ends 112 and 114 of tire base member 110 together to form a complete circular tire cover assembly 100 for enclosing the tire 12 within the tire receiving compartment 122, as shown in FIG. 8 of the drawings. Other forms of connectors can be used to connect together the first and seconds ends 112 and 114 of tire base member 110 with each other, such as snap connecting members 142 and 144 or buckle and tab connectors 152 and 154.

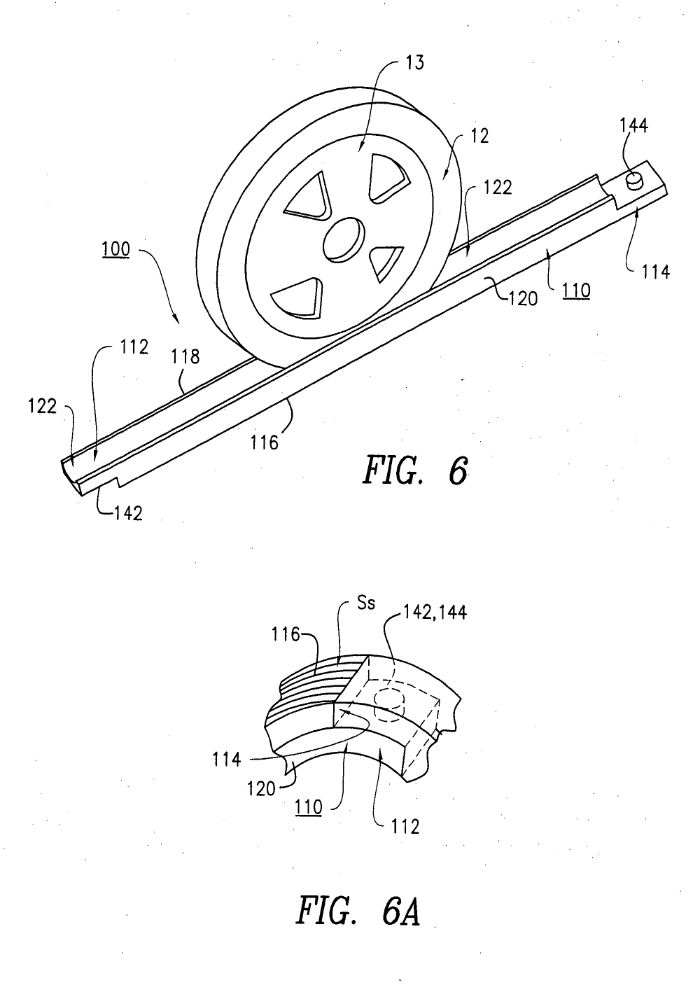

The exterior wall 116 may be made with a smooth surface Sₛ or made with a tread-like surface or ridged surface S_{T}, as shown in FIGS. 5A and 6A of the drawings. The exterior wall 116 has a depth in the range of three (3) to five (5) inches for increasing the radius R of the original tire. The tire receiving compartment (recess) 122 has an interior depth of at least three (3) inches for receiving a section of the original tire 12 therein.

The first and second ends 112 and 114 of the elongated tire base member 110 are mated and matched with the buckle connector 132 and tab connector 134 of each end 112 and 114, respectively, in order to form a complete circular tire cover assembly 100 in which to transport vehicle 14 onto ramp 16 of the transport vehicle 18, as shown in FIG. 8 of the drawings. The tire cover assembly 100 may be made from moldable and semi-rigid plastic materials or rubber materials.

### Operation of the Present Invention

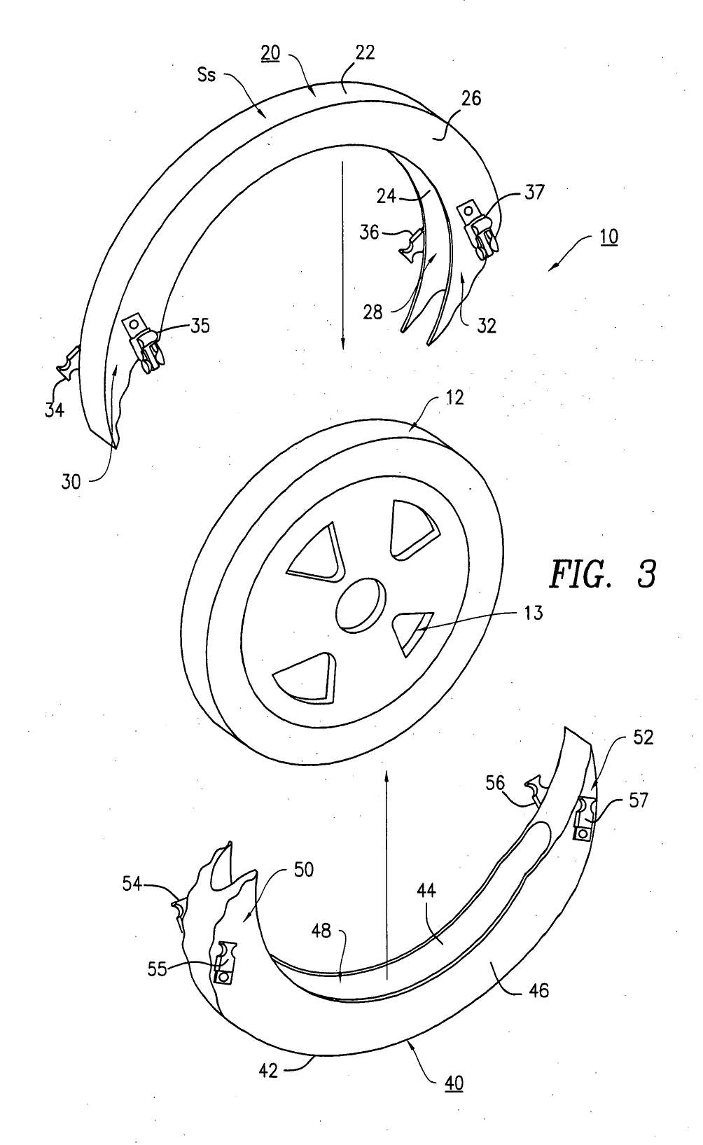

In operating the detachable tire cover assembly 10 or 100 of the preferred and alternate embodiments of the present invention, as shown in FIGS. 3, 4, 7 and 8, the following operational steps are used as follows. Initially, the user drives or rolls the vehicle 14 forward about a foot such that each tire 12 rotates into the first end 30 or the third end 50 of the first and/or second tire receiving compartments 28 and/or 48 allowing the user to install the front end of vehicle 14 in order to gain physical access to front tires 12, as depicted in FIG. 4.

In the next step (for tire cover 10), the user inserts a portion of tire 12 within each of the first and second tire receiving compartments 28 and 48 of half sections 20 and 40, respectively.

In the last step (for tire cover 10), the first and seconds ends 30 and 32 of the first circular shaped half section 20 are mated and matched with the third and fourth ends 50 and 52 of the second circular shaped half section 40, respectively, such that the buckle connectors 34 and 35 are connected with the tab connectors 54 and 55 at the first and third ends 30 and 50 of half sections 20 and 40, respectively. Also, the buckle connectors 36 and 37 are connected with the tab connectors 56 and 57 at the second and fourth ends 32 and 52 of half sections 20 and 40, respectively, in order to form a complete circular tire cover assembly 10 in which to transport vehicle 14 onto a ramp 16 to a vehicle transport 18, as shown in FIG. 4 of the drawings.

In the alternate embodiment for tire cover assembly 100, the next step-has-the user inserting a section of tire 12 within the tire receiving compartment 122, where then the first and second ends 112 and 114 of the elongated tire base member 110 are mated and matched with the buckle and tab connectors 152 and 154 at each end 112 and 114, respectively, in order to form a complete circular tire cover assembly 100 in which to transport vehicle 14 onto ramp 16 of the transport vehicle 18, as shown in FIG. 8 of the drawings.

### Advantages of the Present Invention

Accordingly, an advantage of the present invention is that it provides for a tire cover assembly having a pair of rigid, molded semi-circular halves that are connected together by connectors to form a complete circular tire cover.

Another advantage of the present invention is that it provides for a tire cover assembly that raises the riding height of a vehicle in order for the vehicle to be rolled onto a ramp of a transport vehicle without any denting or damage to the lower front end or back end of vehicle.

Another advantage of the present invention is that it provides for a tire cover assembly that is easy to assemble, install and remove and is, made from durable materials such as plastic or rubber, and is easy to clean.

Another advantage of the present invention is that it provides for a tire cover assembly that can be mass produced in an automated and economical manner and is readily affordable by the user.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

What is claimed is:

1. A detachable tire cover assembly for a vehicle that raises the riding height of the vehicle such that the vehicle may be rolled onto a ramp of a transport vehicle without damage, comprising;
a) a detachable tire cover assembly having a first circular shaped section, and a second circular shaped section;
b) said first and second circular shaped sections each include an exterior wall and side walls thereon for forming first and second tire receiving compartments therein; each of said first and second tire receiving compartments for receiving a portion of a tire therein;
c) said first circular shaped section having a first end and a second end;
d) said second circular shaped section having a third end and a fourth end;
e) said first and third ends each having first connectors thereon for connecting said first and second circular shaped sections of said tire cover to enclose the tire therein; and
f) said second and fourth ends each having second connectors thereon for connecting said first and second circular shaped sections of said tire cover to enclose the tire therein.

2. A tire cover assembly in accordance with claim 1, wherein each of said first and second circular shaped sections are semi-circular shaped half sections.

3. A tire cover assembly in accordance with claim 1, wherein said exterior wall has a smooth surface.

4. A tire cover assembly in accordance with claim 1, wherein said exterior wall has a tread-like surface or a ridged surface.

5. A tire cover assembly in accordance with claim 1, wherein said exterior wall has a depth in the range of three (3) to five (5) inches for increasing the radius of the original tire.

6. A tire cover assembly in accordance with claim 1, wherein said first connector on said first and second ends of said first circular shaped section includes buckle snaps.

7. A tire cover assembly in accordance with claim 1, wherein said second connector on said third and fourth ends of said second circular shaped section includes tab connectors.

8. A tire cover assembly in accordance with claim 1, wherein said tire cover is made from moldable and rigid plastic or rubber materials.

9. A tire cover assembly in accordance with claim 1, wherein each of said first and second tire receiving compartments of said first and second circular shaped sections has an interior depth of at least three (3) inches for receiving a portion of the original tire therein.

10. A tire cover assembly in accordance with claim 1, wherein said first and second ends of said first circular shaped section are mated and matched with said third and fourth ends of said second circular shaped section, respectively, for forming a complete circular tire cover assembly.

11. A detachable tire cover assembly for a vehicle that raises the riding height of the vehicle such that the vehicle may be rolled onto a ramp of a transport vehicle without damage, comprising.
a) a detachable tire cover assembly including an elongated tire base member having a first end and a second end;
b) said elongated tire base member including an exterior wall and side walls thereon for forming a tire receiving compartment for receiving a tire therein; and
c) said first and second ends having connectors thereon for connecting said first and seconds ends to form a complete circular tire cover assembly for enclosing the tire within said tire receiving compartment.

12. A tire cover assembly in accordance with claim 11, wherein said exterior wall has a smooth surface.

13. A tire cover assembly in accordance with claim 11, wherein said exterior wall has a tread-like surface or a ridged surface.

14. A tire cover assembly in accordance with claim 11, wherein said exterior wall has a depth in the range of three (3) to five (5) inches for increasing the radius of the original tire.

15. A tire cover assembly in accordance with claim 11, wherein said connectors on said first and second ends of said elongated tire base member include buckle and tab connectors.

16. A tire cover assembly in accordance with claim 11, wherein said connectors on said first and second ends of said elongated tire base member include snap and tab connectors.

17. A tire cover assembly in accordance with claim 11, wherein said connectors on said first and second ends of said elongated tire base member include hook and loop fasteners.

18. A tire cover assembly in accordance with claim 11, wherein said tire cover assembly is made from moldable and semi-rigid plastic or rubber materials.

19. A tire cover assembly in accordance with claim 11, wherein said tire receiving compartment of said tire base member has an interior depth of at least three (3) inches for receiving a portion of the original tire therein.

20. A tire cover assembly in accordance with claim 11, wherein said first and seconds ends of said tire base member are mated and matched with each other for forming said complete circular tire cover assembly.
